(19) United States
(12) Patent Application Publication
(10) Pub. No.: US 2016/0098944 A1
(43) Pub. Date: Apr. 7, 2016

(54) EYE SURGERY TRAINING SIMULATOR

(71) Applicant: Hung-Yuan Lin, Taipei (TW)

(72) Inventor: Hung-Yuan Lin, Taipei (TW)

(73) Assignee: Universal Vision Biotechnology Co., Ltd., Taipei (TW)

(21) Appl. No.: 14/506,696

(22) Filed: Oct. 6, 2014

(51) Int. Cl. G09B 23/32

(52) U.S. Cl. CPC G09B 23/32

(57) ABSTRACT

The present invention provides an eye surgery training simulator that can reduce learning cost and simulate the eyes in a more real way to allow surgery performers in practice to increase the success rate of surgery. The surgery training simulator compromise: a base with the accommodating tank, a hollow sphere inside said accommodating tank with a punched hole at the center of its top to simulate the eyeball rotation; a thin film covering the punched hole of said hollow sphere to simulate anterior capsule; a positioning sheet attached to the top surface of the hollow sphere with a hole corresponding to the punched hole; a positioning plug-in at the side of said punched hole that can limit the displacement of the capsulorhexis forceps; and at least an elastic component that can simulate eyeball muscle by pulling the hollow sphere and restore it after the rotation of the hollow sphere.

### BACKGROUND OF INVENTION

1. Field of the Invention

The present invention relates generally to simulation equipment, and more particularly to simulation equipment which a lows ophthalmologists to simulate and practice continuous curvilineal capsulorrhexis (hereinafter referred to as, CCC) surgery.

2. Description of Related Art

The function of eyes is to focus the image on retina to provide vision with the help of a crystalline lens by transmitting the light through a transparent outer called cornea. The quality of the focused image is affected by many factors including the size and shape of the eyes, and the transparency of cornea and crystalline lens. When the crystalline lens becomes turbid or even hardened and opaque due to ageing, UV damage or other factors, the light and image cannot be transmitted onto the retina, resulting in blurred vision and cataracts.

Causes of cataracts are multiple and it cannot be treated with a single medicine, which can only postpone the progress of cataracts at best. Up to now, surgery is the only effective method of treatment. Modern cataracts surgical procedure consists of a chain of steps. Each step will affect the smooth embodiment of the next. In cataract extraction surgery, Phaco is the currently safest method of surgery. During the surgery, there is a capsulorhexis action, that is, CCC of anterior capsule of the lens. The step is the first critical step in the entire cataracts surgery. It provides a ring opening of smooth edge in the anterior capsule to ensure the integrity of the suspensory ligament and the surrounding capsule membranes of the lens and ensure the stability of the artificial lens inside the capsule. The success of the step has a direct impact on the smooth embodiment of the cataracts surgical procedure. capsulorhexis surgical tool is capsulorhexis forceps or capsulotomy needle. As the control of capsule membrane is better by using capsulorhexis forceps, it is more favorable for beginners. In the following discussion, capsulorhexis forceps is used as the tool of CCC surgery.

Clinically, in the surgery of maturity, hypermature senile cataracts and some congenital cataracts, traumatic cataracts, nuclear cataracts, it is difficult to distinguish capsulorhexis rim. Therefore, it is considerably difficult to complete a standard CCC surgery. In cataracts surgery, an incision will be made at the side of the transparent cornea for subsequent actions. With the continuous advances in medical technology, the location of the corneal incision is transferred from sclerocornea to cornea; the incision size is gradually reduced from the previous 12 mm, 6 mm, 3 to 3.5 mm to 1.8 to 2.2 mm. There will be a certain degree of difficulty in completing CCC action in such a small range.

Therefore, the performer must often co simulated training cataract surgery operations, so that it can improve the CCC's success rate. The current analogy training method mainly depends on artificial eyes or animal eyes for performer training. However, the training method is not only expensive; it is not easy for performers. Moreover, it takes very long time to train the performer to the level required for surgery. More importantly, after the completion of the training, it requires continuous repeated practices; otherwise, the CCC success rate will fall. Hence, it will reduce medical quality and retraining is likely to take up too much time of doctors.

Secondly, conventional CCC training methods cannot really reflect the condition of surgery on the patient eye because alternative eyes are artificial eyes or animal eyes (e.g. pig eyes). Although these two alternative kinds of eyes can allow trainees to learn basic treatments technology, such technology cannot be fully applied in the surgery on human eyes because eyeballs will rotate continuously due to the effect of eye muscles. By comparison, artificial eyes or animal eyes will not rotate. Therefore, it is not easy to get the surgery level required for performing on human eyes.

Because of this, CCC training or re-training, need to use a lot of artificial eyes or animal eyes. If using artificial eyes, the cost will be very high. If using the animal eyes in training, although the cost is low, the smell of animal eyes may easily affect the performer. In addition, animal eyes are more difficult to preserve and thus are hard to be stored for a long term.

In view of this, how to provide an eye surgery training simulator for training, of repeatedly used, reduced training costs, of easy embodiment, without the problem of preservation in addition to the simulation of real eyes has become the issue to be improved in the present invention.

### SUMMARY OF THE INVENTION

The purpose of the present invention is to provide an eye surgery training simulator that can reduce learning cost, be more close to the real state of the eye and let the performer practice the surgery more easily to improve surgery success rates.

In order to solve the above-mentioned problems and achieve the object of the present invention, the technical solution of the present invention is that a eye surgery training simulator, the features of surgery training simulator comprising an upper accommodating tank and a lower seat connected by the base for support; a punched hole at the center of tie top to simulate the pupil with a hollow of lower part being embedded inside said accommodating tank to rotate like the eyeball; a replaceable thin film covering the surface of the top of said hollow sphere and closing the punched hole to simulate anterior capsule; a transparent positioning sheet of an area larger than the thin film attached to the surface of the upper part of the hollow sphere, the positioning sheet has a hole corresponding to said punched hole; a two pins fixed to the both sides of the punched holes of said hollow sphere for the forceps of capsulorhexis forceps and the positioning plug-in limiting the displacement of forceps; and at least one elastic component connected with the lower part of the hollow sphere at one end and the bottom of said accommodating tank on the other hand to simulate eyeball muscles to provide the resilience to allow the hollow sphere to restore after rotation.
More preferably, wherein said elastic component a straight bar of isoprene polymer material, and has a retractable elastic band rubber band effect.
More preferably, wherein said elastic component is a tension spring with elastic stretching effect.
More preferably, wherein said accommodating tank is a hollow tapered slot with upper notch and lower notch; the diameter of the upper notch is greater than the lower notch; there is a notch opening of equal diameter at the opening of the upper notch.
More preferably, wherein the end of said elastic component is connected with the center of the bottom of the hollow sphere; the other end of the elastic component protrudes downward through the lower notch of the accommodating tank and turns upward to be fixed on the outer wall of the accommodating tank; the preferable positions include the outer wall of the front and the rear sides.
More preferably, wherein there is an L-shaped hook on the outer wall of said accommodating tank, the other end of the elastic component has equally spaced protruding parts that can be connected with the hook.
More preferably, wherein the other end of said elastic component is fixed on the outer wall of the bottom of the accommodating tank.
More preferably, wherein said base further comprises at least a positioning frame connected on the side of said accommodating tank to provide the positioning of the upper part of capsulorhexis forceps; and at least positioning groove installed at the seat of said base below the positioning frame for the positioning of the lower part of capsulorhexis forceps.
More preferably, wherein two narrow-spaced positioning holes are set beside the punched hole of said the hollow sphere; said positioning plug-in has a two-pinned [symbol] shaped rod; after the penetration of two pins through said positioning sheet, after being input inside the positioning holes, [symbol] shaped rod can then stand on the surface of the hollow sphere.
More preferably, wherein the diameter of said punched hole is 8 mm, the diameter of said hole is equal and smaller than the punched hole; the space between two pins of said positioning plug-in is 2 to 3 mm, and the spacing in between the positioning plug-in to the punched hole center is from 5.5 to 7.5 mm.

The function and effect of the present invention are as follows:

First, in the present invention, accommodating tank is used as eye socket, the hollow sphere is used to simulate eyeball, the punched hole is used to simulate the pupil by analogy, the elastic component is to simulate eyeball muscle, the thin film is used to simulate the eye anterior capsule before using the positioning sheet to cover the thin film and attach it onto the surface of the hollow sphere. By matching the hole with the punched hole, it can provide a CCC surgery training simulator for the practice of CCC surgery. It is easy to use without the issue of preservation. More importantly, it can simulate the real eyes without the problems of low surgery success rate and lack of compliance with the practical surgery.

Second, in the present invention, by using the positioning plug-in, it can limit the displacement of capsulorhexis forceps and replace the incision at the side of the transparent cornea. Therefore, it is closer to the real situation in the surgery. More importantly, it can save the incision step so that it is easier for the surgery performer to practice CCC, improve proficiency and success rates.

Third, in the present invention, the overall cost of the surgery training simulator is not high and it can greatly reduce the cost. On the other hand, the part that should be replaced after the use of surgery training simulator is the thin film. The positioning piece is subject to the service life. Hence, the overall maintenance and training costs can be reduced, which, is very conducive to training promotion.

### BRIEF DESCRIPTION OF THE DRAWINGS

FIG. 1 is a perspective schematic view of the present invention;

FIG. 2 is an exploded perspective schematic view of the present invention;

FIG. 3 is a schematic cross-sectional view of the present invention;

FIG. 3A is an enlarged view of a symbol 3A in FIG. 3;

FIG. 4 is a schematic view of an implementation according to the capsulorhexis forceps applied to eye surgery training simulator in the present invention;

FIG. 5 is an enlarged view of a structure of continuous curvilineal capsulorrhexis according to the present invention;

FIG. 6 is a top schematic view of an implementation according to the capsulorhexis forceps applied to eye surgery training simulator in the present invention;

FIG. 7 is a comparison schematic view illustrating correct eye surgery performing and incorrect eye surgery performing when practicing eye surgery in the present invention;

FIG. 8 is another embodiment according to the present invention.

### DETAILED DESCRIPTION OF THE INVENTION

The embodiment as illustrated by the figures is elaborated as follows:

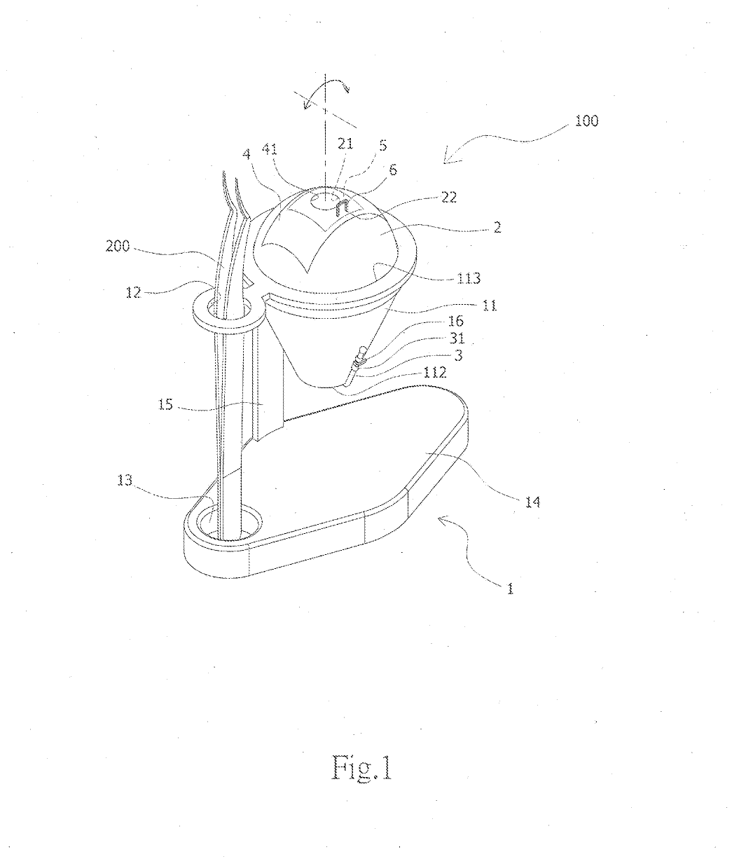

As shown from FIGS. 1 to 3, the eye surgery training simulator 100 mainly compromise a base 1, hollow sphere 2, elastic component 3, positioning sheet 4, thin film 5, positioning plug-in 6 coupled with capsulorhexis forceps 200 to realize the simulation.

Said base 1 compromises an accommodating tank 11 on the top of one end and seat 14, a support 15 connecting accommodating tank 11 and seat 14. The support 15 supports the accommodating tank 11, so that it can be at the appropriate height to facilitate practice. Secondly, support 15 can be adjustable to adjust the height to adapt to the needs of the surgery performers.

In said hollow sphere 2, there is a punched hole 21 to simulate the pupil at the center of its top, its lower part is embedded inside said accommodating tank 11 and can rotate like eyeball inside accommodating tank 11. Therefore, accommodating tank 11 is like eye socket, the hollow sphere 2 is like eyeball.

Said accommodating tank 11 is a hollow taper slot with an upper notch 111 and lower notch 112. The diameter of upper notch 111 is larger than the lower notch 112. In addition, there is a notch opening 113 of the same diameter at the entrance of upper notch 111. When the lower part of hollow sphere 2 is embedded inside the accommodating tank 11, the horizontal axis of hollow sphere 2 is located at the notch opening of equal diameter 113. The sphere below the horizontal axis and upper notch 111 are in linear contact, so that hollow sphere 2 can rotate freely inside the accommodating tank 11.

Said thin film 5 covers the surface of the top of said hollow sphere 2 and closes up punched hole 21. It can simulate anterior capsule and can be replaced and updated at any time.

Said positioning sheet 4 is a transparent film with sticker and its area is greater than said thin film 5. It covers thin film 5 and attaches to the surface of the top of hollow sphere 2. It has a hole 41 in correspondence to said punched hole 21. The thin film 5 is exposed at hole 41. Additionally, for the convenience of sticking and removal by fingers, the positioning sheet 4 should be rectangular. The sticker on the back of the positioning sheet 4 is reusable.

Said positioning plug-in 6 has two pins and are fixed near punched hole 21 of said hollow sphere 2.

There is at least one said elastic component 3, its end 3a is connected with the bottom of hollow sphere 2, it is another end 3b is connected with the bottom of said accommodating tank 11. It can simulate eyeball muscle and provides the resilience force to restore the hollow sphere 2 to the original position after rotation. As there are human eyeball muscles, we can install more components if needed. The positions should be bilaterally asymmetric or sagittally asymmetric.

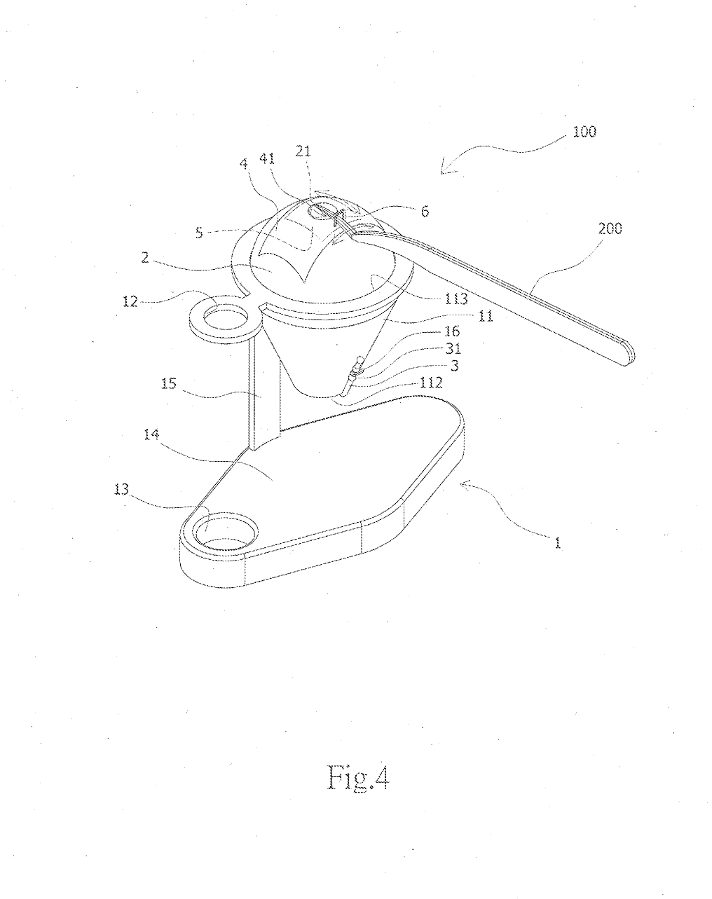

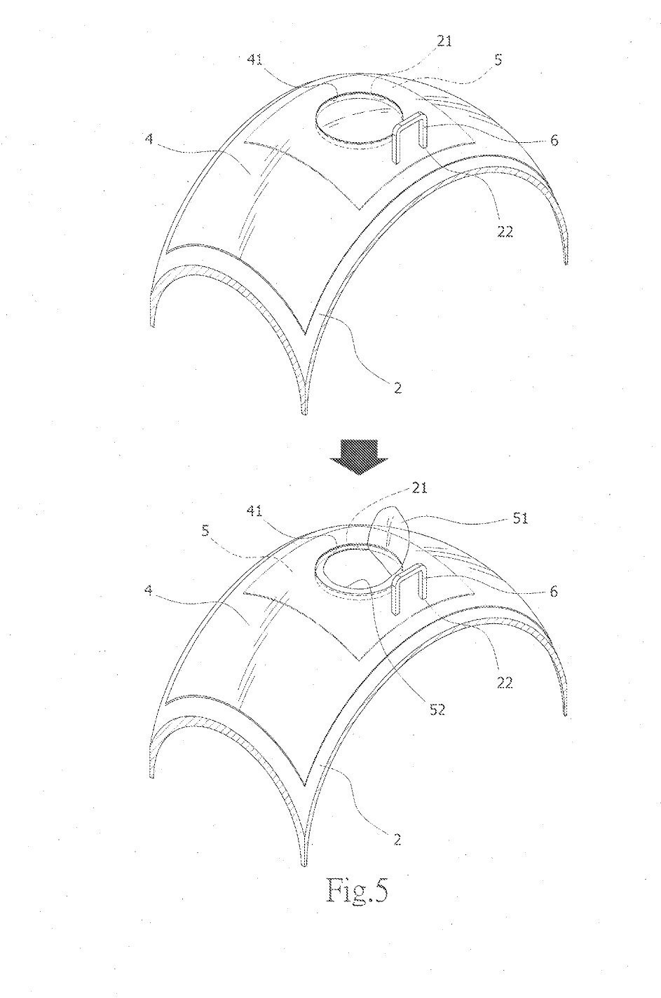

As shown in FIGS. 4 to 5, the present invention is for the practice of CCC surgery. By using hollow sphere 2 to simulate eyeball, punched hole 21 to simulate the pupil, elastic component 3 to simulate eyeball muscle, thin film 5 to simulate anterior capsule, positioning sheet 4 to fix thin film 5; during the practice process, by using the capsulorhexis forceps 200, the thin film 5 of hole 41 can be removed in a continuous ring to result in the tear film 51 and annular opening 52. Overall, the present surgery training simulator 100 is easy to use without the preservation issue. More importantly, hollow sphere 2 simulating eyeball is affected and pulled by elastic component 3, so that it can rotate like the real eye to effectively simulate the conditions of real eyes to make the training closer to embodiment.

Secondly, the application of positioning plug-in 6 can simulate the incision by the side of the transparent cornea to facilitate the surgery performer to use capsulorhexis forceps 200 in practice, so that it can be closer to the real surgery conditions. As using positioning plug-in 6 can save the step of incision and allow the surgery performer to focus on practicing CCC. Therefore, it can improve the proficiency and success rate of surgery.

During the surgery, the front end of capsulorhexis forceps 200 is imported into the positioning plug-in 6 before carrying out the continuous circular tear of thin film 5 of hole 41. In the above Figure, capsulorhexis forceps 200 tears the tear film 51 from right to left. In the following Figure, capsulorhexis forceps 200 tears the tear film 51 from left to right. Therefore, during the present surgery, capsulorhexis forceps 200 needs to move horizontally. As the distance of horizontal movement should not be too great, it should be shorter than the distance of the two pins of positioning plug-in 6. In other words, capsulorhexis forceps 200 can only move in between two pins. No pin can be touched and positioning plug-in 6 cannot be moved, otherwise, hollow sphere 2 may rotate to fail the continuous circular tear.

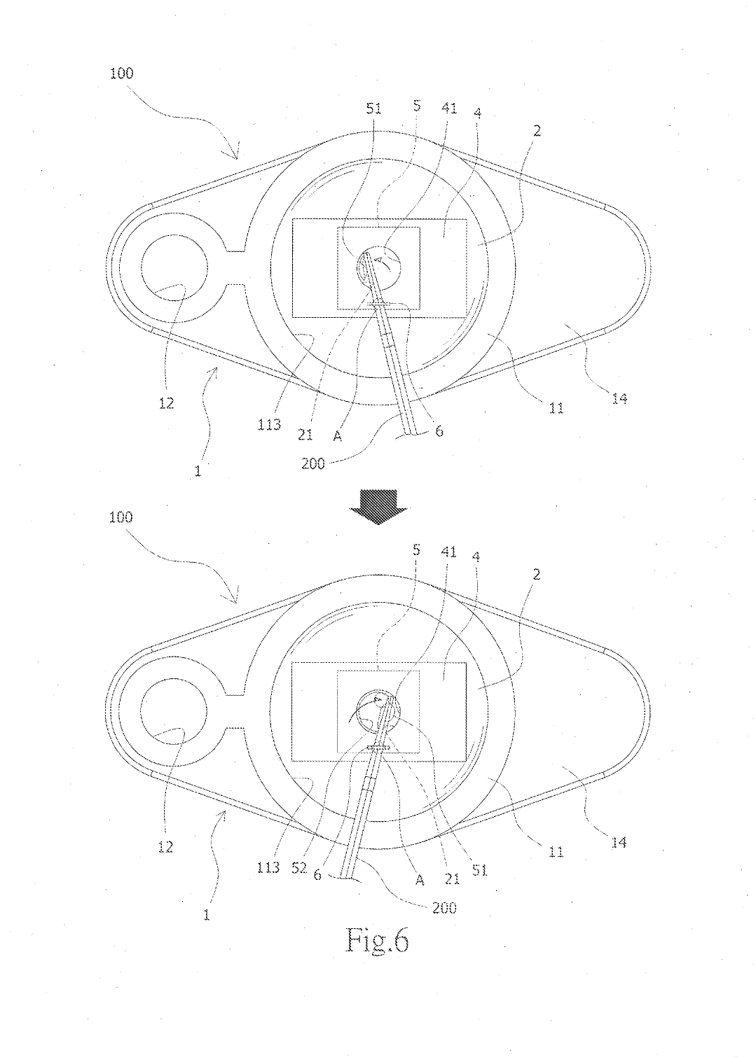

FIG. 6 reveals the correct CCC surgery state. During CCC process, for the integrity of annular opening 52 and closeness to the circular shape, eyeball rotation should be avoided. Hence, the incision at the side of transparent cornea should be avoided; otherwise, eyeball will be triggered to rotate to result in difficulties in surgery or even lead to surgery failure to cause complications. For this reason, it is generally required that capsulorhexis forceps 200 should be regarded as a positioning axis A after touching anterior capsule 51. According to the positioning axis A, the front displacement of capsulorhexis forceps 200 is then adjusted. In addition to the replacement of incision, positioning plug-in 6 can allow the surgery performer to practice the assumption of the existence of positioning axis A to realize smooth CCC surgery.

In the present invention, as continuous circular tear surgery is not the key requirement, skills and means of completing continuous circular tear will not be discussed in detail.

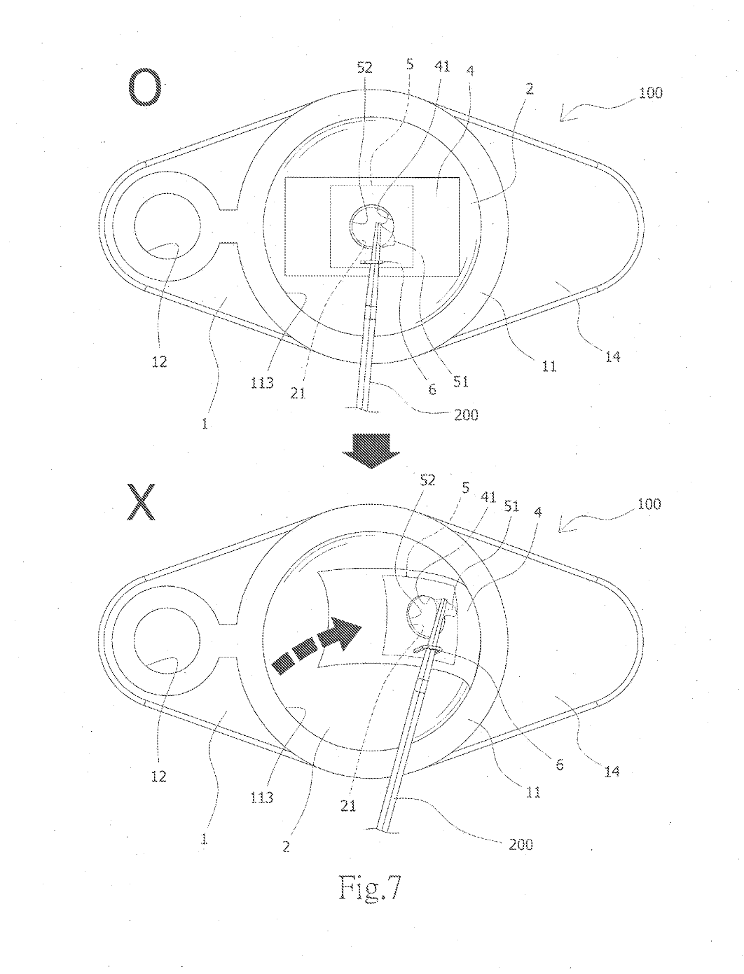

The above image of FIG. 7 illustrates the surgery performer using capsulorhexis forceps 200 in CCC and the below image of FIG. 7 reveals the incorrect action, that is, the front end of capsulorhexis forceps 200 touches the right pin of positioning plug-in 6 and move rightward to result in the right clockwise rotation of hollow sphere 2 to fail CCC. On the contrary, if the front end of capsulorhexis forceps 200 touches the left pin of positioning plug-in 6 and moves rightward (not illustrated) to cause the left clockwise rotation of hollow sphere 2, CCC cannot be successful. Hence, the hand-held capsulorhexis forceps 200 does not touch and push positioning plug-in 6, indicating the continuous circular tear surgery has made progress. The surgery performer will be more confident to complete CCC surgery if seeing the progress.

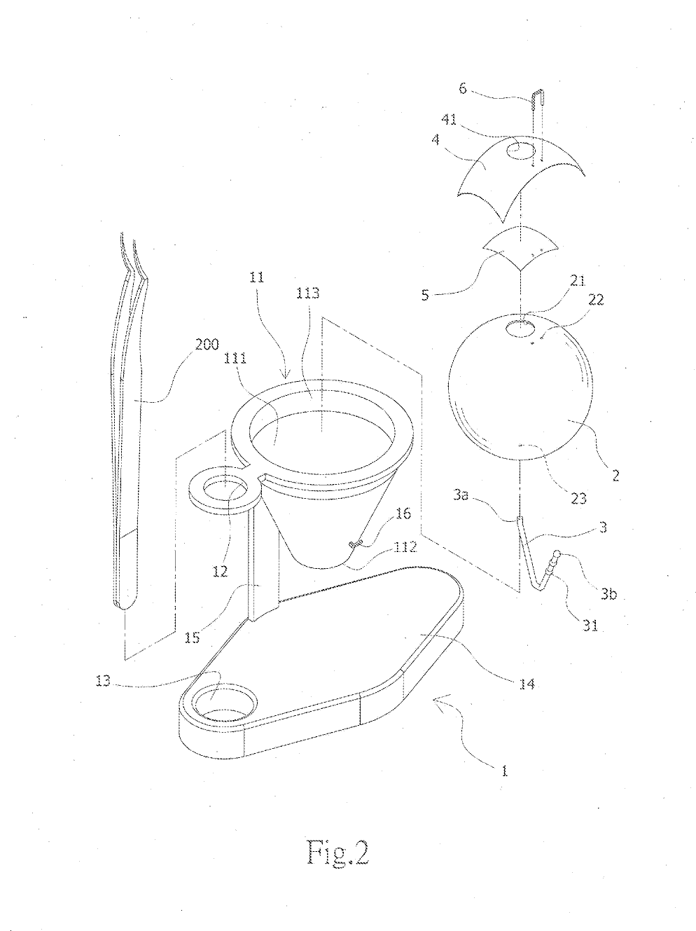

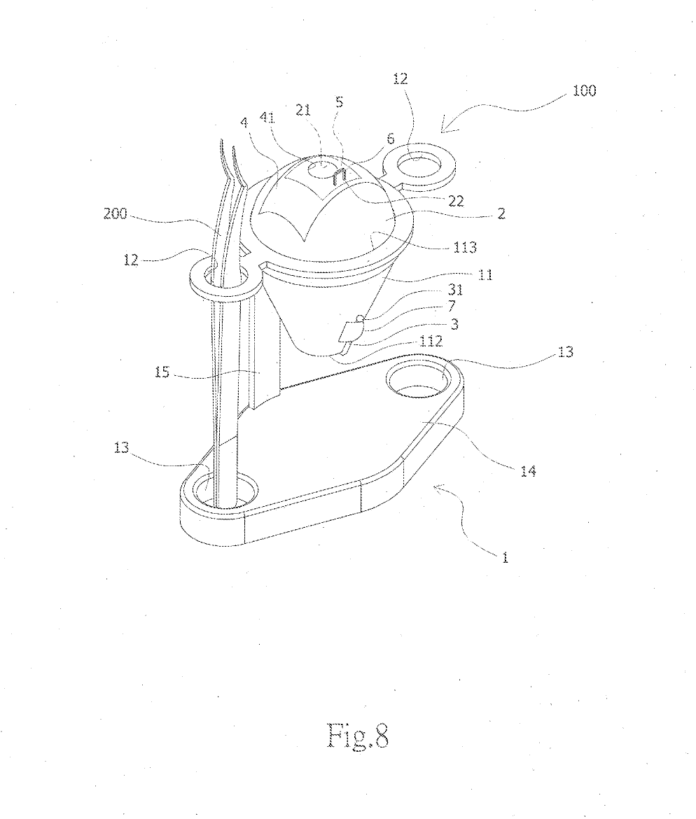

By referring to FIGS. 1 and 2, to facilitate the surgery performer to store and use capsulorhexis forceps 200, beside said accommodating tank 11, a positioning frame 12 for the positioning of the upper part of capsulorhexis forceps 200 is installed. A positioning groove 13 is installed at said seat 14 right below positioning frame 12 for the positioning of the lower part of capsulorhexis forceps 200. It should be noted that base 1 illustrated in Figure is just an example of embodiment, and there are other different embodiments. As shown in FIG. 8, positioning frames 12 are installed on both sides of said accommodating tank 11 for the positioning of the upper part of capsulorhexis forceps 200, and positioning grooves 13 are installed on both sides of base 1 for the positioning of lower part of capsulorhexis forceps 200, making said positioning frame 12 and positioning groove 13 vertically asymmetric in distribution. Based on the above, the number of positioning frame 12 and positioning groove 13 can be increased to more than three according to the real conditions. However, one to four is preferred.

Secondly, there is only one bracket 15 as shown in FIG. 1, two or more brackets can be applied to surround accommodating tank 11 at equal distance, or hollow cylindrical column can be used to replace the multiple bracket 15.

As shown above, said punched hole 21 diameter is 8 mm, said hole 41 and punched hole 21 are of the same size. The distance between two pins of said positioning plug-in 6 is from 2 to 3 mm, the distance from positioning plug-in 6 to the center of punched hole 21 is from 5.5 to 7.5 mm.

As described above, the punched hole 21 is to simulate the pupil, and its size is closer to the real eye state. Hole 41 should match the punched hole 21, therefore, the diameters of hole 41 and punched hole 21 should be the same, or the diameter of hole 41 should be slightly smaller than that of the punched hole 21; regarding the breadth of positioning plug-in 6, it can change according to the size of the incision at the side of transparent cornea to facilitate training. Moreover, the distance between positioning plug-in 6 to the center of punched hole 21 is a distance suitable for capsulorhexis forceps 200 to perform the surgery.

In the present invention, elastic component 3 is in the shape of straight bar as shown in the figure. It is made of isoprene polymer material with the rubber band of retractable and elastic function. It can also be the tensile spring of elastic and retractable functions (not illustrated). By the application of different elastic component 3, it can provide different elasticity changes to provide more diverse practices to meet the training needs surgery to improve proficiency, and further improve the success rate of surgery.

As described above, the isoprene polymer material is a mixture of latex and rubber with excellent elasticity, and it is easy to obtain and manufacture, cheap, capable of changing or reducing stretch at any time. Hence, it is very suitable for elastic component 3 in the present invention.

As described above, the tensile force of the spring is strong, it is not likely to be deformed or deteriorated with a long service life, and thus it is suitable for daily use or a lot of time of practice to maintain stability of surgery performer. It is an elastic component 3 second only to the rubber band.

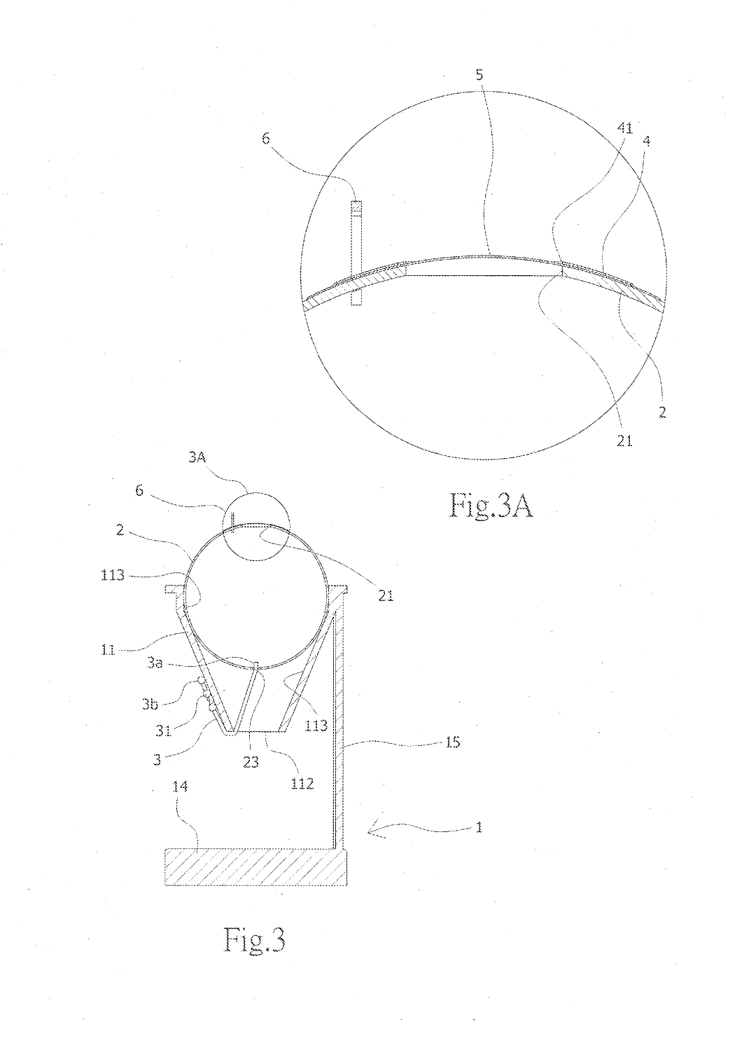

As shown in FIG. 3, the end 3a of said elastic component 3 and the center of the bottom of hollow sphere 2 are connected. The other end 3b of said elastic component 3 extended downward to lower notch 112 of the accommodating tank 11 and is fixed at the outer wall of the bottom part of accommodating tank 11. In practice, the other end 3b of elastic component is preferably fixed at the outer wall of the front or side of accommodating tank 11 because the forces on elastic component 3 can thus be the same and balanced when hollow sphere 2 rotates to the left or the right.

By the above configuration and setup, it can allow the rotation of the hollow sphere 2 coupled with the elastic feedback of elastic component 3 to restore the hollow sphere 2 to the original position. The simple design can simulate the real eyes and allows the surgery performer to practice smoothly to reduce practice costs significantly and considerably.

As described above, when said elastic component 3 is a rubber band, 3b connected with outer wall of accommodating tank 11 is connected in the non-fixed way. As shown in FIG. 2, the outer wall of the bottom of the accommodating tank 11 has a L-shaped hook 15, 3b of elastic component 3 has a few protruding part 31 of equal space. The protruding part 31 and hook 15 can change and adjust the elasticity of the elastic component 3 at any time. Moreover, as shown in FIG. 8, film 7 can be used to attach 3b of the elastic component 3. When the elasticity of elastic component 3 reduces, it needs only to pull 3b of the elastic component 3 outward and use film 7 to fix. The operation is easy, quick and time-saving.

As described above, when said elastic component 3 is the tensile spring, the L-shaped hook on the outer wall of accommodating tank 11 can adjust the elasticity at any time in a convenient and easy way.

With the reusable adhesive positioning sheet 4, thin film 5 can be used easily for positioning without causing displacement. Moreover, after the use, the replacement of the thin film 5 is easy. The positioning sheet 4 can be replaced if expires.

As shown in FIG. 2, two narrow-spaced positioning holes 22 are installed close to the punched hole 21 of said hollow sphere 2. Said positioning plug-in 6 is a [symbol] shaped rod with two pins. When the pins penetrate positioning sheet 4 to get inside the two positioning holes 22, [symbol] shaped rod can then stand on the surface of positioning sphere 2. The installation of positioning hole 22 allows the easy assembly and disassembly of positioning plug-in 6 for the replacement of thin film 5 after installing the positioning sheet.

We claim

1. An eye surgery training simulator, the features of surgery training simulator comprising:
an upper accommodating tank and a lower seat connected by the base. for support;
a punched hole at the center of the top to simulate the pupil with a hollow of lower part being embedded inside said accommodating tank to rotate like the eyeball;
a replaceable thin film covering the surface of the top of said hollow sphere and dosing the punched hole to simulate anterior capsule;
a transparent positioning sheet of an area larger than the thin film attached to the surface of the upper part of the hollow sphere, the positioning sheet has a hole corresponding to said punched hole;
a two pins fixed to the both sides of the punched holes of said hollow sphere for the forceps of capsulorhexis forceps and the positioning plug-in limiting the displacement of forceps; and
at least one elastic component connected with the lower part of the hollow sphere at one end and the bottom of said accommodating tank on the other hand to simulate eyeball muscles to provide the resilience to allow the hollow sphere to restore after rotation.

2. The structure defined in claim 1, wherein said elastic component is a straight bar of isoprene polymer material, and has a retractable elastic bane rubber band effect.

3. The structure defined in claim 1, wherein said elastic component is a tension spring with elastic stretching effect.

4. The structure defined in claim 2, wherein sale accommodating tank is a hollow tapered slot with upper notch and lower notch; the diameter of the upper notch is greater than the lower notch; there is a notch opening of equal diameter at the opening of the upper notch.

5. The structure defined in claim 4, wherein the end of said elastic component is connected with the center of the bottom of the hollow sphere; the other end of the elastic component protrudes downward through the lower notch of the accommodating tank and turns upward to be fixed on the outer wall of the accommodating tank; the preferable positions include the outer wall of the front and the rear sides.

4. structure defined in claim 4, wherein there is an L-shaped hook on the outer wall of said accommodating tank, the other end of the elastic component has equally spaced protruding parts that can be connected with the hook.

7. The structure defined in claim 4, wherein the other end of said elastic component is fixed on the outer wall of the bottom of the accommodating tank.

8. The structure defined in claim 1, wherein said base comprises
at least a positioning frame connected on the side of said accommodating tank to provide the positioning of the upper part of capsulorhexis forceps; and
at least positioning groove installed at the seat of said base below the positioning frame for the positioning of the lower part of capsulorhexis forceps.

9. The structure defined in claim 1, wherein, two narrow-spaced positioning holes are set beside the punched hole of said the hollow sphere; said positioning plug-in has a two-pinned [symbol] shaped rod; after the penetration of two pins through said positioning sheet, after being input inside the positioning holes, [symbol] shaped rod can then stand on the surface of the hollow sphere.

10. The structure defined in claim 1, wherein the diameter of said punched hole is 8 mm, the diameter of said hole is equal and smaller than the punched hole; the space between two pins of said positioning plug-in is 2 to 3 mm, and the spacing in between the positioning plug-in to the punched hole center is from 5.5 to 7.5 mm.
